(19) United States
(12) Patent Application Publication
(10) Pub. No.: US 2002/0063180 A1
(43) Pub. Date: May 30, 2002

(54) Reversed rotation preventive device

(75) Inventors: Kazuyuki Matsuda, Tokyo (JP); Eiji Shinohara, Tokyo (JP); Kazuo Hirano, Saitama (JP); Kyoichi Kaneko, Tokyo (JP)

Correspondence Address: SUGHRUE, MION, ZINN, MACPEAK & SEAS, PLLC, 2100 Pennsylvania Avenue, NW, Washington, DC, 20037-3213, US

(73) Assignee: DAIWA SEIKO, INC.

(21) Appl. No.: 09/977,388

(22) Filed: Oct. 16, 2001

(30) Foreign Application Priority Data
Oct. 16, 2000 (JP) P2000-315102
Oct. 16, 2000 (JP) P2000-315103

(51) Int. Cl. A01K 89/02

(52) U.S. Cl. 242/247; 188/30

(57) ABSTRACT

A fishing reel includes: a fixed member; a rotating member rotatable with respect to the fixed member; a holder provided between the fixed member and the rotating member; and a plurality of rolling member accommodated in the holder for permitting a rotation of the rotating member in one direction and preventing a rotation of the rotating member in the other direction. The plurality of rolling members are provided in wedge regions, defined by the fixed member, rotating member and the holder, having different wedge angles each other, respectively.

### BACKGROUND OF THE INVENTION

The present invention relates to an improvement in a reversed rotation preventive device for permitting a rotation in one direction of a rotating member and preventing a rotation in the other direction.

Under the present circumstances, there has generally been used a fishing reel comprising a reversed rotation preventive device which employs a one way clutch utilizing the wedge action of a roller having a low degree of a reverse rotation play in place of a ratchet method in order to lessen a play during a reverse rotation stop and to enhance a hooking operation property and a fishing line discharge property, for example, as is known in Japanese Unexamined Utility Model publication Nos. Sho. 64-38964, Sho. 64-38963 and Japanese Patent No. 2,996,339.

Under the actual circumstances, a speed or a load applied during the reverse rotation of a driving shaft through a fishing line is varied depending on a countermeasure taken for fighting with fish (an intermittent winding operation or an operation for pulling fish or swinging the rod) in actual fishing.

Under the present circumstances, there has generally been used a one way clutch in the related reversed rotation preventive device of the reel for fishing which has such a structure that an allowable torque is great in a comparative low speed specification (the wedge angle of a roller is set to be comparatively great such that a locking performance is not hindered). During the actual fishing, a reverse rotation stop function is reliably executed by the wedge action when the reverse rotating speed of the driving shaft is comparatively low in relation to object fish or fighting with fish.

Depending on the situation of a fishing place, the driving shaft is rotated at a high speed in the direction of a reverse rotation due to the rapid pull-in or force of the fish. In this case, the roller easily slips on a wedge action surface and a biting property is deteriorated so that the wedge action cannot be reliably obtained and locking cannot be carried out. Thus, there is such a phenomenon that the reverse rotation of the driving shaft cannot be stopped but an idle rotation is caused.

Therefore, there is a problem that the reverse rotation of the driving shaft cannot be reliably stopped by the execution of the wedge action of the roller of the one way clutch under the actual circumstances in which the reverse rotating speed of the driving shaft is varied.

Further, in the related reversed rotation preventive device, the effect of reliably lessening a play during a reverse rotation can be obtained by the wedge action of a one way clutch. However, due to the influence of the wear, damage or corrosion of a sliding contact surface subjected to the wedge action of the roller, the concentricity of a driving shaft and a one way clutch, and furthermore the high-speed reverse rotation of the driving shaft, the wedge action cannot be reliably carried out during the reverse rotation so that a slip might be generated to cause an idle rotation depending on a use environment or a practical situation.

It has been known that two one way clutches are provided on the driving shaft or a one way clutch is provided on a separate driving shaft as described in Japanese Unexamined Utility Model Publication Hei. 5-82281. However, a space for the two one way clutches is required on the driving shaft in a body so that a size and a weight are increased. Consequently, operability and portability are deteriorated and a cost is increased.

Moreover, there is a problem in that incorporation and disassembling properties for manufacture and after-manufacture are poor and handling properties are also deteriorated.

The related reversed rotation preventive device comprising a rolling type one way clutch has a problem in that the wedge action cannot be reliably carried out during the reverse rotation so that a slip might be generated to cause an idle rotation depending on a use environment or a practical situation by the influence of the wear, damage or corrosion of a sliding contact surface subjected to the wedge action of the roller, the concentricity of a driving shaft and a one way clutch, and furthermore, the high-speed reverse rotation of the driving shaft.

When two one way clutches are provided on the driving shaft or a one way clutch is provided on a separate driving shaft, a space for the two one way clutches is required on the driving shaft in a body so that a size and a weight are increased. Consequently, operability and portability are deteriorated and a cost is increased.

Moreover, there is a problem in that incorporation and disassembling properties for manufacture and after-manufacture are poor and handling properties are also deteriorated.

### SUMMARY OF THE INVENTION

In consideration of the drawback described above, it is an object of the invention to provide a reversed rotation preventive device capable of stably maintaining a reverse rotation stop performance through the wedge action of a one way clutch even if the reverse rotating speed of a driving shaft is varied.

Further, it is an object of the invention to provide a reversed rotation preventive device capable of stably maintaining a reverse rotation stop performance by the wedge action of a rolling type one way clutch while preventing an increase in a size and a weight due to the clutch.

In order to solve the aforesaid object, the invention is characterized by having the following arrangement.

(1) A reversed rotation preventive device comprising:

a fixed member;

a rotating member rotatable with respect to the fixed member; and

a one way clutch provided between the fixed member and the rotating member, the one way clutch including

a holder, and

a plurality of rolling members accommodated in the holder so as to permit a rotation of the rotating member in one direction and prevent a rotation of the rotating member in the other direction,

wherein the plurality of rolling members are provided in wedge regions, defined by the fixed member, the rotating member and the holder having different wedge angles each other, respectively.

(2) The reversed rotation preventive device according to (1) further comprising a switching operation member for switching a reversed rotation preventive mode in which the rotation of the rotating member in the one direction is permitted and the rotation in the other direction is prevented and a free rotation mode in which the rotations in both directions are permitted.

(3) A reversed rotation preventive device comprising:

a fixed member;

a rotating member rotatable with respect to the fixed member; and

a one way clutch provided between the fixed member and the rotating member, the one way clutch including

a holder, and

a plurality of rolling member accommodated in the holder so as to permit a rotation of the rotating member in one direction and prevent a rotation of the rotating member in the other direction,

wherein the one way clutch includes a plurality of clutch portions having different wedge angles at which the plurality of rolling members carry out a wedge action.

(4) The reversed rotation preventive device according to (3) further comprising a switching operation member for switching a reversed rotation preventive mode in which the rotation of the rotating member in the one direction is permitted and the rotation in the other direction is prevented and a free rotation mode in which the rotations in both directions are permitted.

(5) A fishing reel for winding a fishline thereon comprising:

a fixed member;

a rotating member rotatable with respect to the fixed member;

a holder provided between the fixed member and the rotating member; and

a plurality of rolling member accommodated in the holder so as to permit a rotation of the rotating member in one direction and prevent a rotation of the rotating member in the other direction,

wherein the plurality of rolling members are provided in wedge regions, defined by the fixed member, rotating member and the holder, having different wedge angles each other, respectively.

(6) The fishing reel according to (3) further comprising a switching operation member for switching a reversed rotation preventive mode in which the rotation of the rotating member in the one direction is permitted and the rotation in the other direction is prevented and a free rotation mode in which the rotations in both directions are permitted.

(7) The fishing reel according to (5), wherein the wedge angles of the wedge regions have a first angle and a second angle smaller than the first angle.

(8) The fishing reel according to (7), wherein the wedge regions of the first angle and the wedge regions of the second angle are alternately formed.

(9) The fishing reel according to (5) further comprising a handle for rotating the rotating member.

(10) The fishing reel according to (5) , wherein the holder is annular and surrounds one of the fixed member and the rotating member, and the other of the fixed member and the rotating member surrounds the holder.

(11) The fishing reel according to (10), wherein the plurality of rolling members are circumferentially provided.

(12) The fishing reel according to (11), wherein the plurality of rolling members are circumferentially provided in double row.

(13) A reversed rotation preventive device:

a fixed member;

a rotating member rotatable with respect to the fixed member;

a one way clutch provided between the fixed member and the rotating member, the one way clutch including

a holder,

a first group including a plurality of rolling member accommodated in the holder so as to permit a rotation of the rotating member in one direction and prevent a rotation of the rotating member in the other direction, and

a second group including a plurality of rolling member accommodated in the holder in double row with the first group so as to permit a rotation of the rotating member in one direction and prevent a rotation of the rotating member in the other direction.

(14) The reversed rotation preventive device according to (13) further comprising a switching operation member for switching a reversed rotation preventive mode in which the rotation of the rotating member in the one direction is permitted and the rotation in the other direction is prevented and a free rotation mode in which the rotations in both directions are permitted.

(15) A fishing reel for winding a fishline thereon comprising:

a fixed member;

a rotating member rotatable with respect to the fixed member;

a one way clutch provided between the fixed member and the rotating member, the one way clutch including

a holder,

a first group including a plurality of rolling member accommodated in the holder so as to permit a rotation of the rotating member in one direction and prevent a rotation of the rotating member in the other direction,

a second group including a plurality of rolling member accommodated in the holder in double row with the first group so as to permit a rotation of the rotating member in one direction and prevent a rotation of the rotating member in the other direction.

(16) The fishing reel according (15) further comprising a switching operation member for switching a reversed rotation preventive mode in which the rotation of the rotating member in the one direction is permitted and the rotation in the other direction is prevented and a free rotation mode in which the rotations in both directions are permitted.

(17) The fishing reel according to (15), wherein the first group and are in phase with the second group.

(18) The fishing reel according to (15), wherein the first group are different in phase with the second group.

### BRIEF DESCRIPTION OF THE DRAWINGS

FIG. 1 is a sectional front view showing a reverse rotation preventing device comprising a rolling type one way clutch according to a first embodiment,

FIG. 2 is an enlarged sectional front view showing a main part,

FIG. 3 is an exploded perspective view showing an outer ring, a cage and a driving shaft in a reverse rotation preventing device comprising a rolling type one way clutch according to a second embodiment,

FIG. 4 is a side view showing the outer ring and the cage,

FIG. 5 is a sectional side view showing the main part of a spinning reel for fishing in a developed example in which the reverse rotation preventing device comprising the rolling type one way clutch according to the second embodiment is incorporated in the spinning reel for fishing,

FIG. 6 is an enlarged sectional side view showing a main part,

FIG. 7 is a sectional front view showing the reverse rotation preventing device,

FIG. 8 is a partially sectional side view showing the reverse rotation preventing device,

FIG. 9 is an exploded perspective view showing an outer ring, a cage and a driving shaft in a reverse rotation preventing device comprising a rolling type one way clutch according to a third embodiment,

FIG. 10 is a sectional front view showing a reverse rotation preventing device comprising a rolling type one way clutch according to a fourth embodiment,

FIG. 11 is an enlarged sectional front view showing a main part,

FIG. 12 is an exploded perspective view showing the reversed rotation preventive device according to a fifth embodiment,

FIG. 13 is a side view showing an outer ring and a holder of the reversed rotation preventive device according to a fifth embodiment,

FIG. 14 is a sectional front view showing the reversed rotation preventive device according to the fifth embodiment,

FIG. 15 is a partially sectional side view showing the reversed rotation preventive device according to the fifth embodiment, and

FIG. 16 is an exploded perspective view showing an outer ring, a holder and a driving shaft of a reversed rotation preventive device according to a sixth embodiment.

### DETAILED DESCRIPTION OF PREFERRED EMBODIMENTS

### First Embodiment

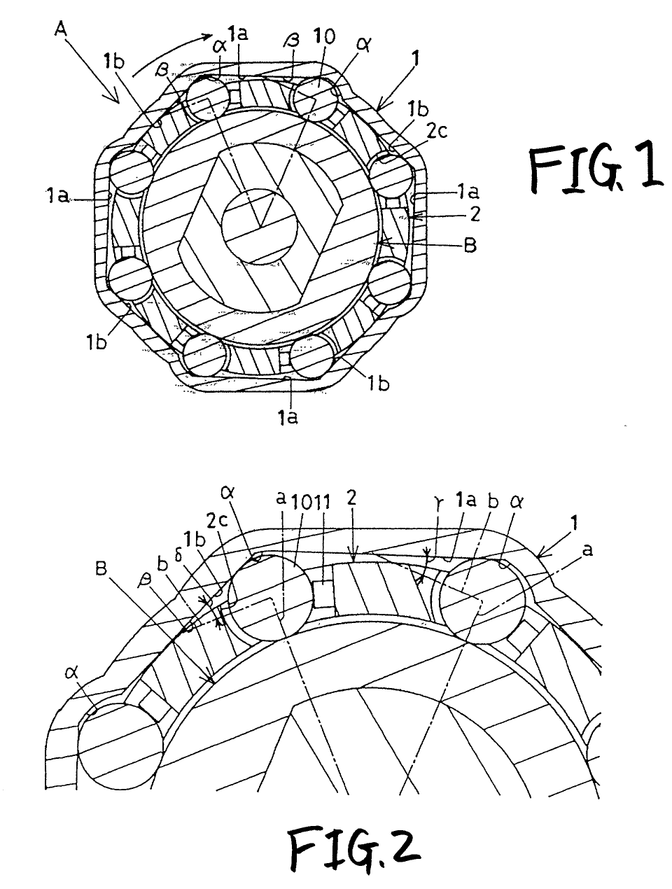

The invention will be described below based on embodiments shown in the drawings. FIGS. 1 and 2 show a first embodiment of a reversed rotation preventive device comprising a rolling type one way clutch, FIG. 1 being a sectional front view showing the reversed rotation preventive device and FIG. 2 being an enlarged sectional front view showing a main part.

In a reversed rotation preventive device A comprising a rolling type one way clutch, a holder 2 is attached to the inside of an outer ring 1, bar-shaped rolling members 10 for carrying out a wedge action is accommodated in a plurality of housing holes of the holder 2, and a driving shaft B is fitted on the inner periphery of the holder 2.

The inner peripheral surface of the outer ring 1 is provided with a free rotation region α of the bar-shaped rolling member 10 in a concave portion and a blocking surface β for preventing a rotation by bringing the bar-shaped rolling member 10 into contact with the blocking surface.

The blocking surface β includes an inner peripheral surface 1a having a great wedge angle and an inner peripheral surface 1b having a small wedge angle which are alternately formed.

The wedge angle is defined by angle of the inner peripheral surface 1a or 1b with respect to a center line b of the bar-shaped rolling member 10 which is perpendicular to a line a connecting the center of the outer ring 1 and that of the bar-shaped rolling member 10, and one of the wedge angles is indicated as γ and the other wedge angle is indicated as δ.

The wedge angle γ gives a great allowable torque for a static torque with 8 degrees to 10 degrees, for example.

The wedge angle δ gives a small allowable torque for a dynamic torque with 6 degrees to 8 degrees, for example.

The holder 2 is formed by a cylindrical portion 2a and a circular plate 2b, and is provided with a plurality of housing holes 2c in the circumferential direction of the cylindrical portion 2a.

The bar-shaped rolling member 10 and a spring member 11 are inserted in each of the housing holes 2c.

When the rolling member 10 is inserted in each of the housing holes 2c, the rolling member 10 is arranged on the outer periphery of the driving shaft B, and is inserted in the concave portion of the outer ring 1 and is urged in the direction of the blocking surface β by the spring member 11.

In FIG. 1, the outer ring 1 acts as a fixed member and the driving shaft B acts as a rotating member.

In the operation of the reversed rotation preventive device A comprising the rolling type one way clutch shown in FIG. 1, when the driving shaft B is normally rotated in a clockwise direction, the holder 2 is also rotated by friction so that the rolling member 10 is positioned in the free rotation region α and is brought into a non-operation state in which the wedge action is not carried out, and the driving shaft B can be normally rotated in the clockwise direction.

Next, when the driving shaft B is reversely rotated in a counterclockwise direction, the holder 2 is also rotated by friction so that the rolling member 10 is positioned in the blocking surface β and is brought into an operation state in which the wedge action is carried out, and the rotation of the driving shaft B in the counterclockwise direction is prevented so that the reverse rotation cannot be carried out.

At this time, when a static torque in the direction of the reverse rotation is applied in the state that the driving shaft B is stopped, a great wedge angle γ is applied so that a static locking property is increased.

When the driving shaft B is instantaneously rotated reversely or when the dynamic torque is applied when the stopper is turned on during the reverse rotation, a small wedge angle δ is applied so that a dynamic locking property is increased.

The static torque is great and the dynamic torque is small at the great wedge angle γ and the dynamic torque is great and the static torque is small at the small wedge angle δ. By alternately combining the great wedge angle γ and the small wedge angle δ, their static locking properties and dynamic locking properties can be increased.

When the reversed rotation preventive device is constituted as described above, the rolling member 10 in a region having the wedge angle γ in which a high-speed property is poor but an allowable torque is great acts with priority during a low-speed reverse rotation, and the rolling member 10 in a region having the small wedge angle δ in which a allowable torque is small but a instantaneous wedge action locking function property is high acts with priority during a high-speed reverse rotation even if the reverse rotating speed of the driving shaft B is changed between a low-speed rotation and a high-speed rotation by a change in the actual situation. Consequently, the reverse rotation preventive function can be obtained sufficiently stably corresponding to the change in the reverse rotating speed of the driving shaft B.

### Second Embodiment

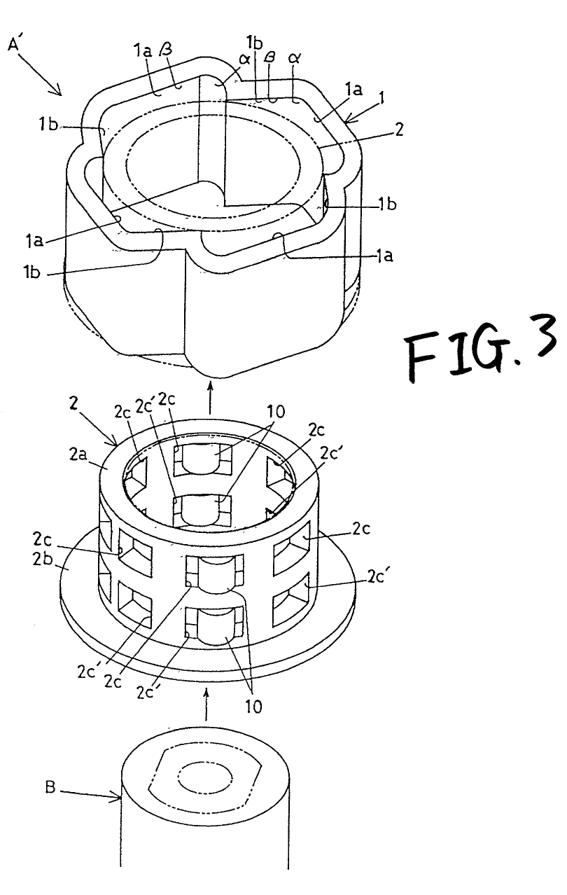

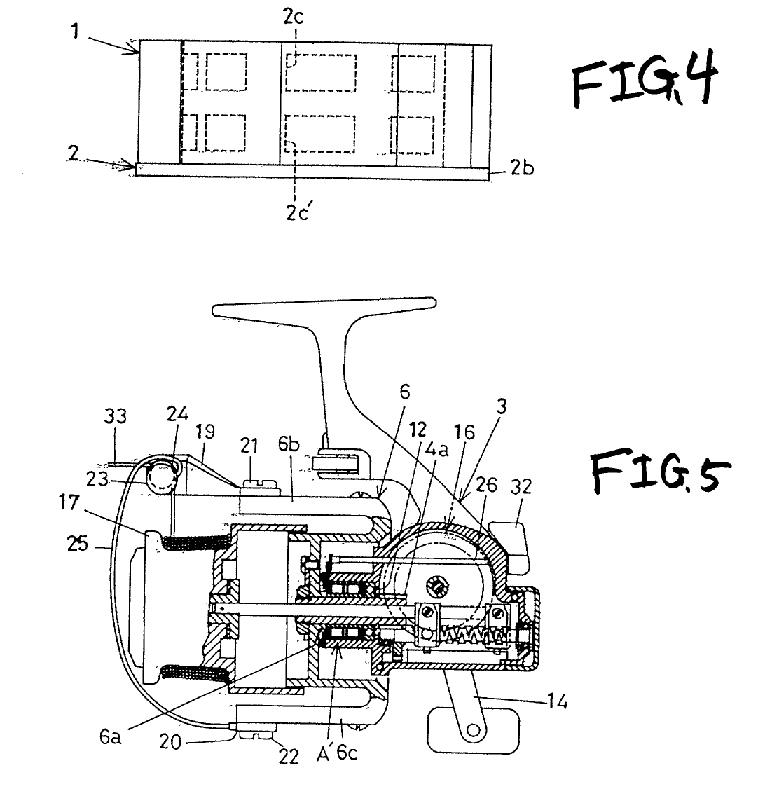

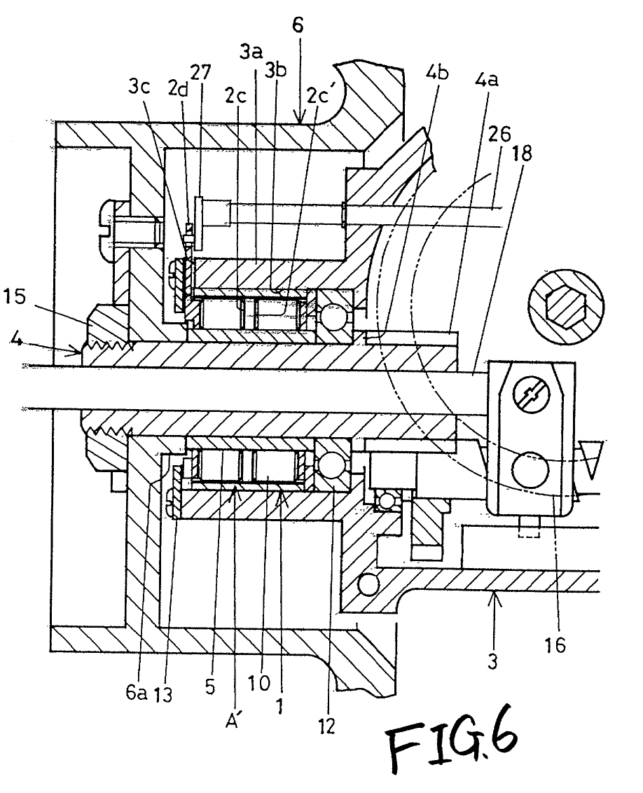

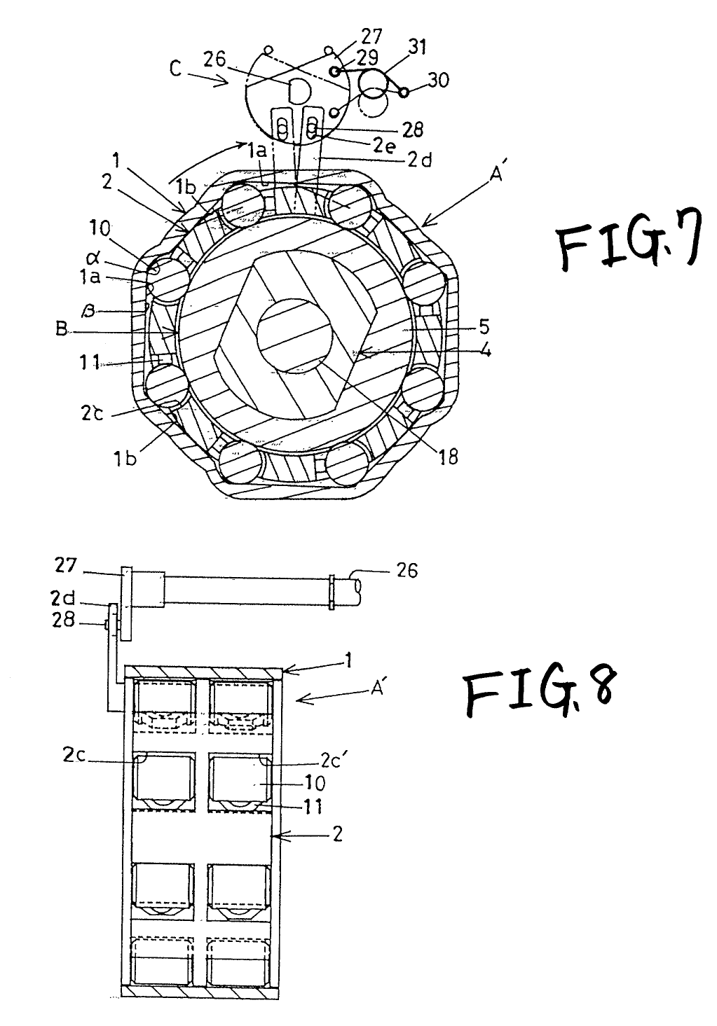

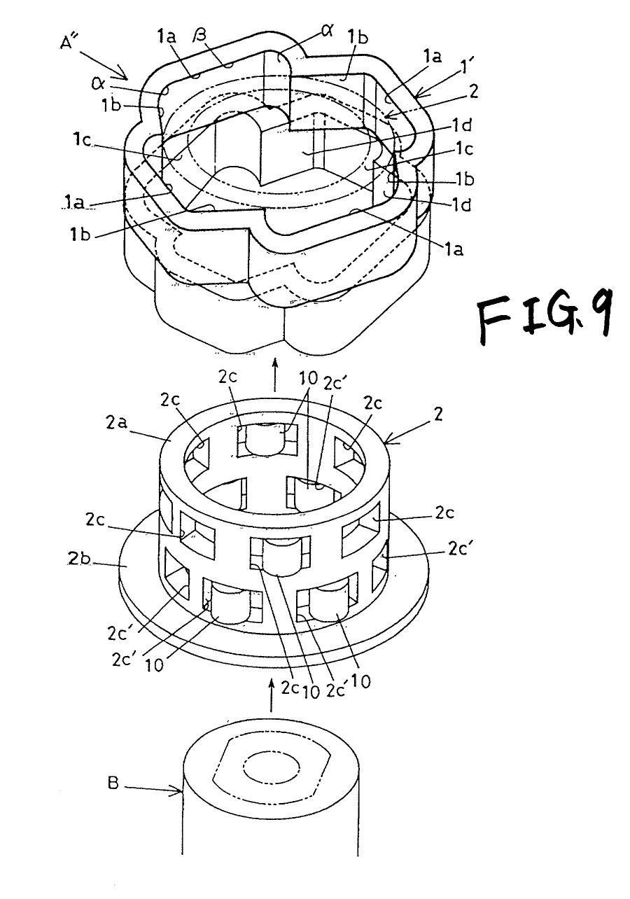

FIGS. 3 and 4 show a second embodiment of the reversed rotation preventive device comprising a rolling type one way clutch, FIG. 3 being an exploded perspective view showing an outer ring, a holder and a driving shaft and FIG. 4 being a side view showing the outer ring and the holder.

In a reversed rotation preventive device A′ comprising a rolling type one way clutch, a holder 2 is attached to the inside of an outer ring 1, a plurality of housing holes in the circumferential direction of the holder 2 are formed in a plurality of rows (two rows in this embodiment) in an axial direction, each accommodating a bar-shaped rolling member 10 for carrying out a wedge action, and a driving shaft B is fitted on the inner periphery of the holder 2.

The inner peripheral surface of the outer ring 1 is provided with a free rotation region α of the bar-shaped rolling member 10 in a concave portion and a blocking surface β for blocking a rotation by bringing the bar-shaped rolling member 10 into contact with the blocking surface.

The blocking surface β includes an inner peripheral surface 1a having a great wedge angle and an inner peripheral surface 1b having a small wedge angle which are alternately formed.

The holder 2 is formed by a cylindrical portion 2a and a circular plate 2b, and is provided with a plurality of housing holes 2c in the circumferential direction of the cylindrical portion 2a and a plurality of housing holes 2c′ formed in double row in the axial direction with respect to the housing holes 2c.

The bar-shaped rolling member 10 and a spring member are inserted in each of the housing holes 2c and 2c′.

When the rolling member 10 is inserted in each of the housing holes 2c and 2c′, the rolling member 10 is arranged on the outer periphery of the driving shaft B, and is inserted in the concave portion of the outer ring 1 and is urged in the direction of the blocking surface β by the spring member.

Other structures are almost identical to those in the first embodiment.

The operation of the reversed rotation preventive device A′ in the second embodiment is almost identical to that of the first embodiment. The cylindrical portion 2a of the holder 2 is provided with the plurality of housing holes 2c in a circumferential direction and the plurality of housing holes 2c′ in the double row in the axial direction in which the rolling members 10 are inserted, respectively. Therefore, the rolling member 10 carries out the wedge action with a double row between the outer peripheral surface of the driving shaft B and the inner peripheral surface of the outer ring 1.

The reversed rotation preventive device constituted as described above incorporates the holder 2 having the plurality of housing holes 2c and 2c′ like the double row in the axial direction in one outer ring 1 of the fixed member and the rolling member 10 inserted therein. Therefore, the effects of the first embodiment can be obtained in the double row.

FIGS. 5 to 8 show a mounting example in which the reversed rotation preventive device according to the second embodiment is incorporated in a spinning reel for fishing, FIG. 5 being a sectional side view showing the main part of the spinning reel for fishing, FIG. 6 being an enlarged sectional side view showing the main part, FIG. 7 being a sectional front view showing the reversed rotation preventive device, and FIG. 8 being a partially sectional side view showing the reversed rotation preventive device.

In the spinning reel for fishing, a bearing 12 and the reversed rotation preventive device A′ comprising a rolling type one way clutch according to the second embodiment are inserted in a concave portion 3b of a front side support portion 3a of the reel body 3 and are prevented from slipping off by using a slip-off stop plate 13, and the outer ring 1 of the reversed rotation preventive device A′ is fitted into the concave portion 3b so as to prevent from rotating.

A cylindrical interlocking shaft 4 which is rotated in conjunction with the rotation of a handle 14 is rotatably supported by the bearing 12 and the reversed rotation preventive device A′. The driving shaft B is constituted by the interlocking shaft 4 and an inner ring 5 including a collar which is locked and fitted in the outer periphery of the interlocking shaft 4.

In the mounting example, the support portion 3a acts as the fixed member of the reel body 3 and the driving shaft B acts as a rotating member.

A pinion 4a and an abutment portion 4b are formed integrally with the base end of the interlocking shaft 4. The bearing 12 abuts on the abutment portion 4b.

The inner ring 5 and a central cylinder portion 6a of a rotor 6 are fitted in the front side of the bearing 12. The inner ring 5 and the central cylinder potion 6a are attached with a nut 15 screwed into the front end of the interlocking shaft 4.

A driving gear 16 is mated with the pinion 4a formed integrally with the front side of the base end of the interlocking shaft 4 so that the rotor 6 is supported to be rotated in conjunction with the rotation of the handle 14.

A spool shaft 18 which a spool 17 attached to a tip thereof is slidably inserted in the central hole of the interlocking shaft 4 to allow longitudinal reciprocative motion.

The driving gear 16 is pivotally supported by the reel body 3 and a bearing which is not shown and is attached to a cover member that is not shown, and is rotated by the handle 14.

In the rotor 6, a bail support member 19 and a bail support member 20 are pivotally supported by support pins 21 and 22 provided to the outside of the tip portions of a pair of bail support arms 6b and 6c, respectively, so as to be adapted to be inverted in a fishing line winding position and a fishing line play out position which is not shown.

A roller attachment potion 23 of a fishing line guide portion for rotatably holding a line roller 24 is attached to the bail support member 19.

A bail 25 is attached between the bail support member 20 and the roller attachment portion 23.

In the reversed rotation preventive device A′, the holder 2 is fitted in the outer periphery of the inner ring 5 including a collar locked and fitted in the outer periphery of the interlocking shaft 4 of the driving shaft B, and the rolling member 10 for carrying out a wedge action is accommodated in a plurality of housing holes 2c and 2c′ of the holder 2 and is mounted on the outer periphery of the inner ring 5 as described in the first and second embodiments.

The inner peripheral surface of the outer ring 1 is provided with a free rotation region α of the bar-shaped rolling member 10 in a concave portion and a blocking surface β for preventing a rotation by bringing the bar-shaped rolling member 10 into contact with the blocking surface.

In the same manner as in FIG. 2, the blocking surface β includes an inner peripheral surface 1a having a great wedge angle and an inner peripheral surface 1b having a small wedge angle which are alternately formed.

The outer periphery of the holder 2 is fitted in the inner peripheral surface of the outer ring 1.

An operation lever 2d is provided integrally with the side surface of the holder 2 of the reversed rotation preventive device A′.

A slot 2e is formed on the free end of the operation lever 2d.

The operation lever 2d is inserted in a notch 3c of the support portion 3a and is protruded toward the outside of the support portion 3a, and is prevented from slipping off by the slip-off stop plate 13.

An operation beam 26 is rotatably attached to the reel body 3 and a switching operation plate 27 is fixed to the front side of the operation beam 26 so that an operating portion 28 formed by a pin fixed to the switching operation plate 27 is inserted in the slot 2e.

A dead point spring 31 is provided between a pin 29 fixed to the switching operation plate 27 and a pin 30 fixed to the reel body 3.

An operation knob 32 is attached to the operation beam 26 protruded toward the rear outside of the reel body 3.

A switching operation member C is constituted by the operation beam 26, the switching operation plate 27, the operating portion 28, the pin 29 and the dead point spring 31.

In the operation of the reversed rotation preventive device A′, when the operation knob 32, the operation beam 26 and the switching operation plate 27 are rotated so that the operation lever 2d is rotated to a position shown in a solid line of FIG. 7, the operation lever 2d of the holder 2 is rotated in a clockwise direction so that the rolling member 10 is positioned in the free rotation region a and is brought into a non-operation state in which the wedge action is not carried out, that is, a free rotation mode. Therefore, the normal and reverse rotations of the rotor 6 and the interlocking shaft 4 can be carried out.

Next, when the operation knob 32, the operation beam 26 and the switching operation plate 27 are rotated so that the operation lever 2d is rotated into a position shown in a two-dotted line of FIG. 7, the operation lever 2d of the holder 2 is rotated in a counterclockwise direction and the rolling member 10 is positioned on the blocking surface β for preventing a rotation of the rolling member 10 so that an operation state in which the wedge action is carried out, that is, a reversed rotation prevented mode is brought. Therefore, since the rolling member 10 can be moved in the clockwise direction against the spring member 11, the normal rotations of the rotor 6 and the interlocking shaft 4 can be carried out. However, the rolling member 10 is abutted to the blocking surface β by a reverse rotation so that the reverse rotation cannot be carried out by the wedge action.

In the operation of the spinning reel for fishing, when the operation knob 32, the operation beam 26, the switching operation plate 27 and the holder 2 are rotated so that the operation lever 2d is rotated to the position shown in the solid line of FIG. 7, the rolling member 10 is brought into a non-operation state (a free rotation mode) in which the wedge action is not carried out in the free rotation region a, and when the handle 14 is rotated in such a direction that a fishing line 33 is wound upon the spool 17, the driving gear 16 is rotated so that the interlocking shaft 4 and the rotor 6 are normally rotated through the pinion 4a.

When the fishing line 33 is wound upon the spool 17, the fishing line 33 is guided through the line roller 24 of the fishing line guide portion provided in the bail support member 19 and is reciprocated longitudinally and is thus wound upon the spool 17 in parallel.

In the case that the rotor 6 is requested to be prevented from rotating in reverse direction, the operation knob 32, the operation beam 26, the switching operation plate 27 and the holder 2 are rotated so that the operation lever 2d is rotated to the position shown in the two-dotted line of FIG. 7, and the operation state (the reversed rotation prevented mode) in which the wedge action is carried out in the blocking surface β for preventing a rotation of the rolling member 10 is brought.

When the fishing line 33 is reeled out due to the pull of a game (fish) so that the rotor 6 is reversely rotated in the counterclockwise direction, the interlocking shaft 4 and the rotor 6 are urged in the reverse rotating direction.

However, since the rolling member 10 is positioned on the blocking surface β for preventing the rotation in abutment, the reverse rotation can be prevented by the wedge action.

At this time, furthermore, a plurality of housing holes 2c in a circumferential direction are formed in the cylindrical portion 2a of the holder 2, a plurality of housing holes 2c′ in a double row are formed in an axial direction and the rolling member 10 is inserted therein. Therefore, the rolling member 10 carries out the wedge action in a double row between the outer peripheral surface of the driving shaft B and the inner peripheral surface of the outer ring 1. Consequently, the degree of a play is low during the reverse rotation so that the reverse rotation of the rotor 6 can be stopped very quickly.

As described above, the holder 2 for holding the rolling member 10 of the reversed rotation preventive device A′ is rotatably supported and the operating portion 28 of the switching operation plate 27 supported by the reel body 3 is engaged with the slot 2e of the operation lever 2d provided in the holder 2 so that the reversed rotation preventive device A′ can be switched into the operation state (the reversed rotation prevented mode) in which the wedge action is carried out and the non-operation state (the free rotation mode) in which the wedge action is not carried out. Therefore, practical use can be attained widely. When the reversed rotation preventive device A′ is incorporated in the spinning reel for fishing, a stable reverse rotation stop function can be obtained also in a fishing reel in which the reverse rotating speed of the driving shaft B is remarkably changed. Thus, a reliable fight with fish can be carried out.

Even if the reversed rotation preventive device A according to the first embodiment is incorporated in the spinning reel for fishing, almost the same effects can be obtained.

While the spinning reel for fishing is taken as an example of the reel incorporating the reversed rotation preventive device A′ in the above description, the invention can be carried out for a reel of another type.

### Third Embodiment

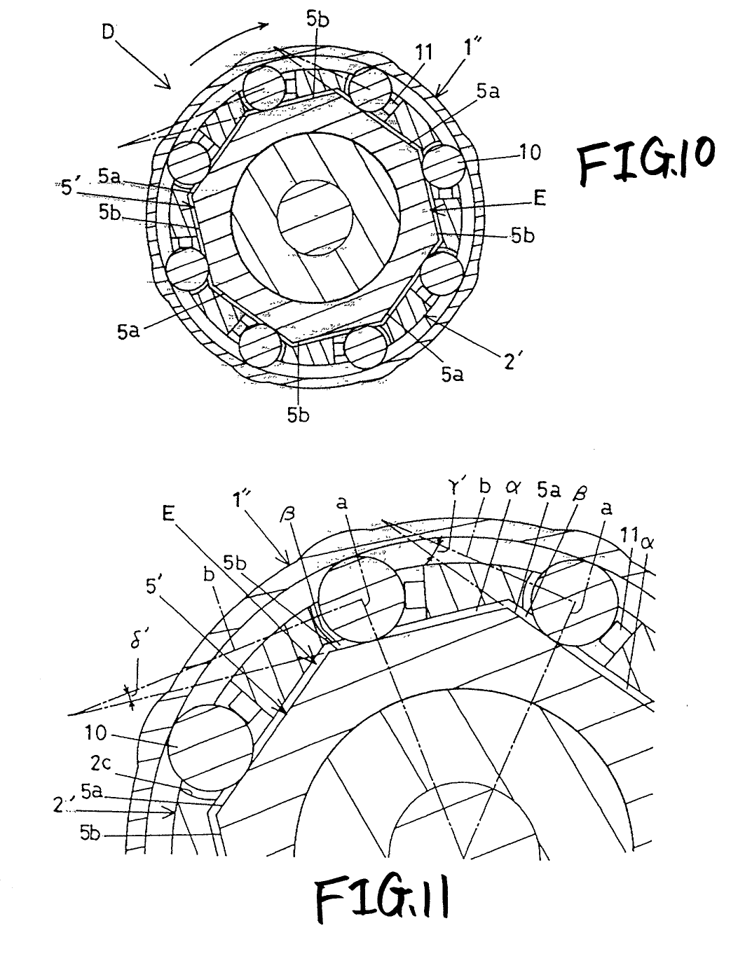

FIG. 9 shows a third embodiment of the reversed rotation preventive device comprising the rolling type one way clutch and is an exploded perspective view showing an outer ring, a holder and a driving shaft.

In a reversed rotation preventive device A″ comprising a rolling type one way clutch according to the third embodiment, a plurality of housing holes 2c′ in a double row are formed in an axial direction with a phase changed for each raw with respect to a plurality of housing holes 2c formed in a circumferential direction in a cylindrical portion 2a of a holder 2.

A free rotation region α of a bar-shaped rolling member 10 formed by a concave portion and a blocking surface β for preventing a rotation of the bar-shaped rolling member 10 are provided on the inner peripheral surface of an outer ring 1′ with phases changed for each row.

In the same manner as in FIG. 2, the blocking surface β includes inner peripheral surfaces 1a and 1c having great wedge angles and inner peripheral surfaces 1b and 1d having small wedge angles which are alternately formed.

Other structures are almost identical to those of the first embodiment.

In the reversed rotation preventive device constituted as in the third embodiment, the holder 2, in which the housings 2c and 2c′ are formed in a double row in the axial direction with phases changed and the rolling members 10 are respectively inserted therein, is incorporated in the outer ring 1′. Therefore, even in a strict use environment and actual circumstances, a one way clutch function can be displayed more reliably by the wedge action of the double-row rolling member 10 of the one way clutch, a reverse rotation stop performance can be maintained stably and reliably, and excellent incorporation and disassembling properties can obtained.

Since the holder 2 provided with the housing holes 2c and 2c′ in a double row in the axial direction which insert the rolling member 10 therein is incorporated in one outer ring 1′ of a fixed member, the effects of the first embodiment can be displayed in the double row.

### Fourth Embodiment

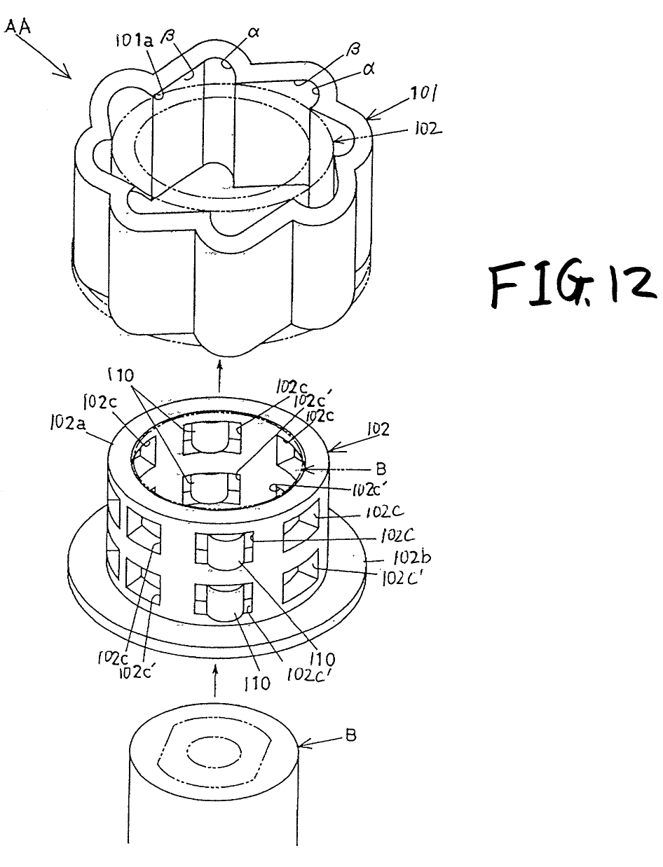

FIGS. 10 and 11 show a fourth embodiment of the reversed rotation preventive device comprising the rolling type one way clutch, FIG. 10 being a sectional front view showing the reversed rotation preventive device and FIG. 11 being an enlarged sectional front view showing a main part.

In a reversed rotation preventive device D comprising a rolling type one way clutch, a holder 2′ is attached to the inside of an outer ring 1″ for rotating in conjunction with rotation of a handle and a plurality of housing holes 2c are formed in the circumferential direction of a cylindrical portion 2a of the holder 2′ and a bar-shaped rolling member 10 and a spring member 11 which carry out a wedge action are accommodated in the housing holes 2c and the holder 2′ is attached and fixed to the outer periphery of a fixing support portion E to be fixed to an unmovable member for attaching the reversed rotation preventive device D.

When the rolling members 10 are inserted in the housing holes 2c, respectively, the rolling members 10 are mounted on the outer periphery of the fixing support portion E.

The inner peripheral surface of the outer ring 1″ is in round shape.

In FIG. 10, the outer ring 1″ acts as a rotating member.

The outer periphery of an inner ring 5′ of the fixing support portion E is formed to have a polygonal shape and is provided with a blocking surface β for preventing a rotation of the bar-shaped rolling member 10 and a free rotation region α.

The blocking surface β includes an inner peripheral surface 5a having a great wedge angle and an inner peripheral surface 5b having a small wedge angle which are alternately formed.

The wedge angle is represented by angles of the inner peripheral surface 5a or 5b with respect to a center line b of the bar-shaped rolling member 10 which is perpendicular to a line a connecting the center of the outer ring 1″ and that of the bar-shaped rolling member 10, and one of the wedge angles is indicated as γ′ and the other wedge angle is indicated as δ′.

The wedge angle γ′ gives a great allowable torque for a static torque with 8 degrees to 10 degrees, for example.

The wedge angle δ′ gives a small allowable torque for a dynamic torque with 6 degrees to 8 degrees, for example.

The blocking surface β is constituted on the other outer peripheral surface side at the left side in the drawing and the free rotation region α is constituted on the other outer peripheral surface side at the right side in the drawing.

The inner peripheral surface of the holder 2′ is formed to have a polygonal shape corresponding to the outer peripheral surface side of the inner ring 5′.

In the reversed rotation preventive device D constituted as described above, the rolling member 10 in a region having the wedge angle γ′, in which a high-speed property is poor and a allowable torque is great, acts with priority during a low-speed reverse rotation, and the rolling member 10 in a region having a wedge angle δ′, in which a allowable torque is low and a instantaneous wedge action locking function property is high, acts with priority during a high-speed reverse rotation even if the reverse rotating speed of the outer ring 1″ is changed between a low-speed rotation and a high-speed rotation by a change in the actual situation. Consequently, the reverse rotation stop function can be obtained sufficiently stably corresponding to the change in the reverse rotating speed of the outer ring 1″.

While the great wedge angle and the small wedge angle are alternately provided in the circumferential direction in the above description, the same wedge angle may be set in the circumferential direction and the great wedge angle and the small wedge angle may be provided alternately like a double row in the axial direction.

### Fifth Embodiment

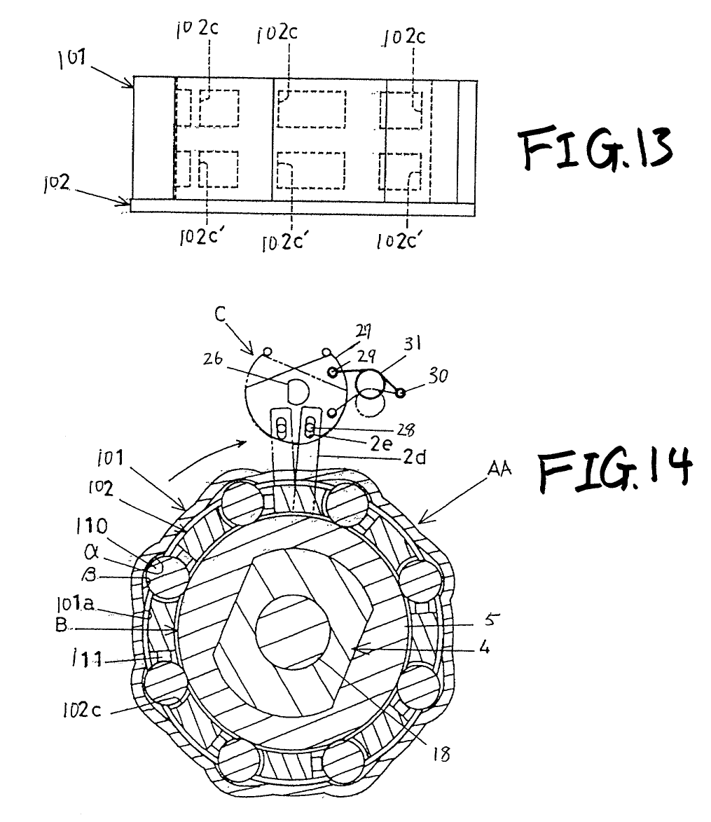

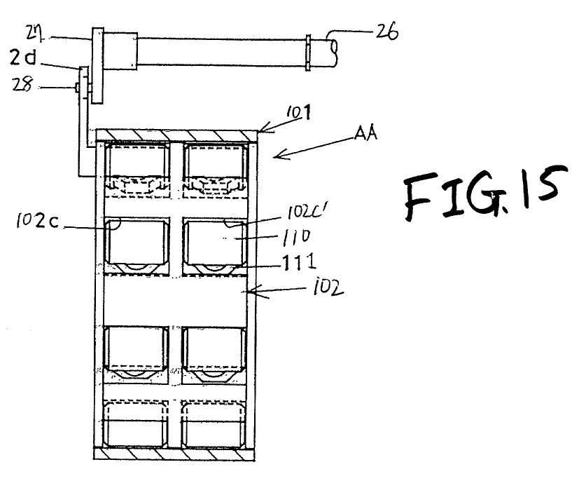

FIGS. 12 to 15 show a fifth embodiment of a reversed rotation preventive device comprising a rolling type one way clutch, FIG. 12 being an exploded perspective view showing the reversed rotation preventive device, FIG. 13 being a side view showing an outer ring and a holder, FIG. 14 being a sectional front view showing the reversed rotation preventive device, and FIG. 15 being a partially sectional side view showing the reversed rotation preventive device.

In a reversed rotation preventive device AA comprising a rolling type one way clutch, a holder 102 is attached to the inside of an outer ring 101, bar-shaped rolling members 110 for carrying out a wedge action is accommodated in a plurality of housing holes of the holder 102, and a driving shaft B is fitted on the inner periphery of the holder 102.

The inner peripheral surface of the outer ring 101 is provided with a free rotation region α of the bar-shaped rolling member 110 in a concave portion and a blocking surface β for preventing a rotation by bringing the bar-shaped rolling member 110 into contact with the blocking surface.

The holder 102 is formed by a cylindrical portion 102a and a circular plate 102b, and is provided with a plurality of housing holes 102c, 102c′ in the circumferential direction of the cylindrical portion 102a and a plurality of housing holes 102c′ formed in a double row in the axial direction with respect to the housing holes 102c.

The bar-shaped rolling member 110 and a spring member 111 are inserted in each of the housing holes 102c and 102c′.

When the rolling member 110 is inserted in each of the housing holes 102c and 102c′ , the rolling member 110 is arranged on the outer periphery of the driving shaft B, and is inserted in the concave portion of the outer ring 201 and is urged in the direction of the blocking surface β by the spring member.

In the operation of the reversed rotation preventive device A shown in FIG. 14, when the driving shaft B is normally rotated in a clockwise direction, the holder 102 is also rotated by friction so that the rolling member 110 is positioned in the free rotation region α and is brought into a non-operation state in which the wedge action is not carried out, and the driving shaft B can be normally rotated in the clockwise direction.

Next, when the driving shaft B is reversely rotated in a counterclockwise direction, the holder 102 is also rotated by friction so that the rolling member 110 is positioned in the blocking surface δ and is brought into an operation state in which the wedge action is carried out, and the rotation of the driving shaft B in the counterclockwise direction is prevented so that the reverse rotation cannot be carried out.

The cylindrical portion 102a of the holder 102 is provided with the plurality of housing holes 102c in a circumferential direction and the plurality of housing holes 102c′ in the double row in the axial direction in which the rolling members 110 are inserted, respectively. Therefore, the rolling member 110 carries out the wedge action with a double row between the outer peripheral surface of the driving shaft B and the inner peripheral surface of the outer ring 101.

As shown in FIG. 14, the outer ring 101 serves as a fixed member and the driving shaft B serves as a rotating member.

As shown in FIG. 14, a switching operation member (described hereafter) is incorporated in the holder 102 of the reversed rotation preventive device AA.

In the reversed rotation preventive device having the structure described above, the holder 102 having a plurality of housing holes 102c and 102c′ in a double row in an axial direction and a rolling member 110 inserted therein are incorporated in the outer ring 101 as a fixed member. Therefore, even in a strict use environment or actual situation, a sufficient strength and durability can be maintained to reliably display a one way clutch function by the complex wedge action in the axial direction of the double row rolling member 110 provided in the axial direction of the one way clutch, a reverse rotation stop performance can be maintained stably and reliably and excellent incorporation and disassembling properties can also be obtained while preventing an increase in a size and a weight.

The reversed rotation preventive device in the fifth embodiment may be mounted on a spinning reel as shown in FIGS. 5 to 8 in the second embodiment. In the case of mounting the reversed rotation preventive device on the spinning reel, the reversed rotation preventive device is provided between the outer peripheral of the interlocking shaft 4 of the driving shaft B which is rotated in conjunction with the rotation of the handle 14 and the reel body 3. Therefore, the even in use in outside particularly in a strict use environment (invasion of saltwater, water, foreign particle or the like, and change in external force, reversed rotation speed or the like) stable reversed rotation prevented function can be obtained, and angler can securely fight with a fish.

### Sixth Embodiment

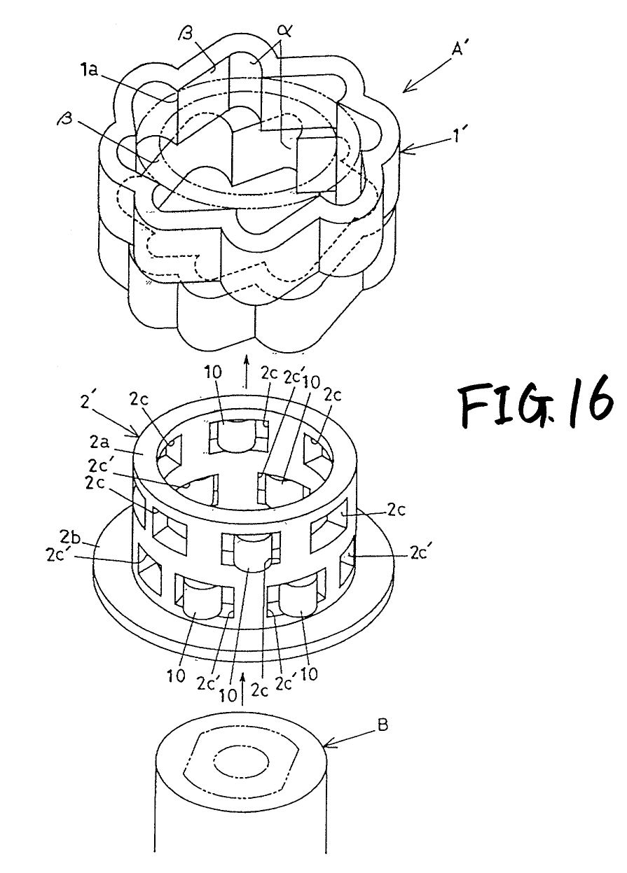

FIG. 16 shows a sixth embodiment of the reversed rotation preventive device comprising the rolling type one way clutch and is an exploded perspective view showing an outer ring, a holder and a driving shaft.

In a reversed rotation preventive device AA′ comprising a rolling type one way clutch according to the sixth embodiment, a plurality of housing holes 102c′ in a double row are formed in an axial direction with a phase changed for each raw with respect to a plurality of housing holes 102c formed in a circumferential direction in a cylindrical portion 102a of a holder 102.

A free rotation region α of a bar-shaped rolling member 110 formed by a concave portion and a blocking surface β for preventing a rotation of the bar-shaped rolling member 110 are provided on the inner peripheral surface of an outer ring 101′ with phases changed for each row.

Other structures are almost identical to those of the fifth embodiment.

In the reversed rotation preventive device constituted as in the sixth embodiment, the holder 102, in which the housings 102c and 102c′ are formed in a double row in the axial direction with phases changed and the rolling members 110 are respectively inserted therein, is incorporated in the outer ring 101′. Therefore, even in a strict use environment and actual circumstances, a one way clutch function can be displayed more reliably by the wedge action of the double-row rolling member 10 of the one way clutch, a reverse rotation stop performance can be maintained stably and reliably, and excellent incorporation and disassembling properties can obtained.

Since the holder 2 provided with the housing holes 2c and 2c′ in a double row in the axial direction which insert the rolling member 10 therein is incorporated in one outer ring 1′ of a fixed member, the effects of the first embodiment can be displayed in the double row while preventing an increase in a size and a weight.

While the spinning reel for fishing is taken as an example of the reel incorporating the reversed rotation preventive device comprising the rolling type one way clutch in the above description, the invention can be carried out for a reel of another type.

The invention is carried out in the embodiments described above and has the following effects.

According to the invention, even if the reverse rotating speeds of the driving shafts are changed from a low speed rotation to a high speed rotation depending on a change in the actual situation, the rolling member in the region having the wedge angle, in which a high-speed property is poor and a allowable torque is great, acts with priority during a low-speed reverse rotation, and the rolling member in the region having the small wedge angle, in which a allowable torque is small and a instantaneous wedge action locking function property is high, acts with priority during a high-speed reverse rotation. Consequently, a reverse rotation stop function can be obtained fully stably corresponding to a change in the reverse rotating speed of the driving shaft.

Further according to the invention, the clutch body having the wedge angle varied is provided between the fixed member and the rotating member. Therefore, it is possible to obtain a stable reverse rotation stop function which sufficiently corresponds to various changes in the reverse rotating speeds of a low-speed rotation and a high-speed rotation, and to provide the clutch body on different driving shafts. Therefore, the degree of freedom of a design can be increased. Moreover, parts can be exchanged depending on the respective situations of the wear and damage of the clutch and maintenance can also be enhanced.

Further, according to the invention, it is possible to switch the operation state (the reversed rotation prevented mode) in which the reversed rotation preventive device carries out the wedge action and the non-operation state (the free rotation mode) in which the reversed rotation preventive device does not carry out the wedge action. Therefore, the invention can be practically used widely.

Further, according to the invention, when the reversed rotation preventive device comprising the rolling type one way clutch is incorporated in the spinning reel for fishing, a stable reverse rotation stop function can be obtained and a fight with fish can be reliably carried out also in a reel for fishing in which the reverse rotating speed of the driving shaft B is remarkably changed.

Further, according to the invention, since the holder having a plurality of housing holes in a double row in an axial direction and a rolling member inserted therein is incorporated in the outer ring as a fixed member, even in a strict use environment or actual situation, a sufficient strength and durability can be maintained to reliably display a one way clutch function by the wedge action of the double row rolling member provided in the axial direction of the one way clutch, a reverse rotation stop performance can be maintained stably and reliably and excellent incorporation and disassembling properties can also be obtained while preventing an increase in a size and a weight.

Further, according to the invention, in a fishing reel to be utilized outdoors, particularly, in a strict use environment (the invasion of seawater, water or foreign substances, a change in external force or a reverse rotating speed or the like), a stable reverse rotation stop function can be obtained and a reliable fight with fish can be carried out.

What is claimed is

1. A reversed rotation preventive device comprising:
a fixed member;
a rotating member rotatable with respect to the fixed member; and
a one way clutch provided between the fixed member and the rotating member, the one way clutch including
a holder, and
a plurality of rolling members accommodated in the holder so as to permit a rotation of the rotating member in one direction and prevent a rotation of the rotating member in the other direction,
wherein the plurality of rolling members are provided in wedge regions, defined by the fixed member, the rotating member and the holder having different wedge angles each other, respectively.

2. The reversed rotation preventive device according to claim 1 further comprising a switching operation member for switching a reversed rotation preventive mode in which the rotation of the rotating member in the one direction is permitted and the rotation in the other direction is prevented and a free rotation mode in which the rotations in both directions are permitted.

3. A reversed rotation preventive device comprising:
a fixed member;
a rotating member rotatable with respect to the fixed member; and
a one way clutch provided between the fixed member and the rotating member, the one way clutch including
a holder, and
a plurality of rolling member accommodated in the holder so as to permit a rotation of the rotating member in one direction and prevent a rotation of the rotating member in the other direction,
wherein the one way clutch includes a plurality of clutch portions having different wedge angles at which the plurality of rolling members carry out a wedge action.

4. The reversed rotation preventive device according to claim 3 further comprising a switching operation member for switching a reversed rotation preventive mode in which the rotation of the rotating member in the one direction is permitted and the rotation in the other direction is prevented and a free rotation mode in which the rotations in both directions are permitted.

5. A fishing reel for winding a fishline thereon comprising:
a fixed member;
a rotating member rotatable with respect to the fixed member;
a holder provided between the fixed member and the rotating member; and
a plurality of rolling member accommodated in the holder so as to permit a rotation of the rotating member in one direction and prevent a rotation of the rotating member in the other direction,
wherein the plurality of rolling members are provided in wedge regions, defined by the fixed member, rotating member and the holder, having different wedge angles each other, respectively.

6. The fishing reel according to claim 3 further comprising a switching operation member for switching a reversed rotation preventive mode in which the rotation of the rotating member in the one direction is permitted and the rotation in the other direction is prevented and a free rotation mode in which the rotations in both directions are permitted.

7. The fishing reel according to claim 5, wherein the wedge angles of the wedge regions have a first angle and a second angle smaller than the first angle.

8. The fishing reel according to claim 7, wherein the wedge regions of the first angle and the wedge regions of the second angle are alternately formed.

9. The fishing reel according to claim 5 further comprising a handle for rotating the rotating member.

10. The fishing reel according to claim 5, wherein the holder is annular and surrounds one of the fixed member and the rotating member, and the other of the fixed member and the rotating member surrounds the holder.

11. The fishing reel according to claim 10, wherein the plurality of rolling members are circumferentially provided.

12. The fishing reel according to claim 11, wherein the plurality of rolling members are circumferentially provided in double row.

13. A reversed rotation preventive device:
a fixed member;
a rotating member rotatable with respect to the fixed member;
a one way clutch provided between the fixed member and the rotating member, the one way clutch including
a holder,
a first group including a plurality of rolling member accommodated in the holder so as to permit a rotation of the rotating member in one direction and prevent a rotation of the rotating member in the other direction, and
a second group including a plurality of rolling member accommodated in the holder in double row with the first group so as to permit a rotation of the rotating member in one direction and prevent a rotation of the rotating member in the other direction.

14. The reversed rotation preventive device according to claim 13 further comprising a switching operation member for switching a reversed rotation preventive mode in which the rotation of the rotating member in the one direction is permitted and the rotation in the other direction is prevented and a free rotation mode in which the rotations in both directions are permitted.

15. A fishing reel for winding a fishline thereon comprising:
a fixed member;
a rotating member rotatable with respect to the fixed member;
a one way clutch provided between the fixed member and the rotating member, the one way clutch including
a holder,
a first group including a plurality of rolling member accommodated in the holder so as to permit a rotation of the rotating member in one direction and prevent a rotation of the rotating member in the other direction,
a second group including a plurality of rolling member accommodated in the holder in double row with the first group so as to permit a rotation of the rotating member in one direction and prevent a rotation of the rotating member in the other direction.

16. The fishing reel according claim 15 further comprising a switching operation member for switching a reversed rotation preventive mode in which the rotation of the rotating member in the one direction is permitted and the rotation in the other direction is prevented and a free rotation mode in which the rotations in both directions are permitted.

17. The fishing reel according to claim 15, wherein the first group and are in phase with the second group.

18. The fishing reel according to claim 15, wherein the first group are different in phase with the second group.
